(19) United States
(12) Patent Application Publication
(10) Pub. No.: US 2013/0213912 A1
(43) Pub. Date: Aug. 22, 2013

(54) PRODUCE DISPLAY TRAY

(71) Applicant: RICHARD STEVEN NAHA, Denver, CO (US)

(72) Inventor: RICHARD STEVEN NAHA, Denver, CO (US)

(21) Appl. No.: 13/398,283

(22) Filed: Feb. 16, 2012

(51) Int. Cl. A47F 7/00

(52) U.S. Cl. 211/85.4

(57) ABSTRACT

A produce display apparatus, comprising: a sloped upper display portion, with at least one slot and at least one aperture in the slot, for positioning produce with a root system therein; a fluid reservoir portion overlaid by the upper display portion, wherein at least a part of the root system of the produce positioned on the upper display portion is in fluid communication with fluid in the reservoir portion, wherein a non-root portion of the produce is substantially located above the upper surface of the upper display portion and the root system lies substantially below the upper display portion.

### RELATED APPLICATIONS

This application is related to U.S. design application Ser. No. 29/408,143, filed on Dec. 7, 2011 by the same applicant as the present application, the disclosure of which is incorporated herein by reference.

### FIELD AND BACKGROUND OF THE INVENTION

The present invention relates to commercial produce in general, and more particularly to an apparatus for improving produce display characteristics and preserving produce shelf life.

United States Patent Application Publication No. US 2007/0271841 to Bissonnette, et al., which is incorporated herein by reference, describes methods and devices for receiving and/or delivering liquid to an object, devices for delivering liquid to a plant/seed/growing medium comprising: a conduit comprising: at least two about parallel plates one or more walls substantially sealing the plates and forming a substantially enclosed space, such that the devices are useful in hydroponic gardens. This application also describes providing hydroponic gardens with such devices. The parallel plates and the walls can be rigid and hydrophobic.

European Application Publication No. EP 1606993 to Mori, et al., which is incorporated herein by reference, describes a device having a shape capable of receiving the plant body to be cultivated. As at least a portion of the device, a film which can substantially be integrated with the root of the plant body is disposed. Such a structure can provide a plant-cultivating device, a plant-film integrate, and a plant-cultivating method which can preferably attain both of the supply of oxygen and the supply of water and a fertilizer component to the root of the plant body.

PCT Application Publication No. WO 2005/025299 to Harding, et al., which is incorporated herein by reference, describes a hydroponic display stand that can be used in the commercial environment or in the home and provides nutrients to the hydroponically grown plants such as lettuce and herbs to extend their shelf life and keep them in a substantially fresh state for a relatively longer period before their sale or use.

U.S. Pat. No. 4,622,775 to Glenn, et al., which is incorporated herein by reference, describes collars, for supporting plants by the base of their stems with the major portion of the root structure extending downward into an aqueous hydroponic medium, have upstanding sidewalls and bottom end structures that support the plant while leaving at least about 75 percent of the bottom area open for the roots to extend through. The collars are very small having a volume less than about one tenth that which would normally be considered adequate to conventionally culture plants in a solid support medium. Vertical foils extend radially inward from the sidewall to prevent the roots, in their early stages of development, from spiraling around the sidewall.

U.S. Pat. No. 4,513,533 to Gething, et al., which is incorporated herein by reference, describes methods wherein plants are hydroponically grown on rafts that float on an aqueous nutrient medium. The rafts have arrays of openings that extend from their upper surface to their lower surface for receiving plant-containing collars that dip into the aqueous medium. To provide efficient plant thinning without plant destruction, a fraction of the openings of the array of each raft is filled directly with plant-containing collars and the remaining plant collars are placed in a grid that overlies the raft and has openings aligned with a fraction of the openings of the array.

U.S. Pat. No. 4,407,092 and U.S. Pat. No. 4,299,054 to Ware, which are incorporated herein by reference, describe hydroponic assemblies in the form of a tray having spaced through-openings serving as growing stations, the tray being supported by a trough containing a body of nutrient solution. At each growing station there is a wafer of dry compressed growing medium having a seed-receiving surface on its top side and having a wick communicating with its underside and extending downwardly into the nutrient solution, the growing medium being of the type capable of expanding three-dimensionally into a porous root-supporting block as the solution is fed via the wick by capillary action. The land surface surrounding each opening is formed into a well or receptacle for maintaining the porous block seated and generally aligned with the opening. A transparent cover of hollow inverted shape defines an enclosed space developing high humidity for sprouting of the seeds and growth of the resulting seedlings, the cover, tray and trough being interfitted. The wick is preferably secured to the underside of the wafer by being tacked in place with a metal staple.

### SUMMARY OF THE INVENTION

An aspect of the present invention relates to providing a produce display apparatus which extends the life and attractive appearance of produce displayed thereon. In some embodiments of the invention, produce is displayed on the apparatus with at least a portion of the produce's root system intact and extending beneath an upper display portion of the apparatus. Optionally, the at least a portion of the root system is in fluid communication with a fluid reservoir located beneath the upper display tray in the apparatus. Optionally, the leafy portion of the produce remains above the upper surface of the upper display portion. In an embodiment of the invention, the fluid reservoir is provided by a fluid reservoir portion of the apparatus which lies beneath the upper display tray portion. In some embodiments of the invention, a raised reservoir portion is provided to the apparatus to provide fluids to produce displayed on the upper tray portion.

In an embodiment of the invention, the upper display portion of the apparatus is sloped upwardly from front to back. The slope is provided to improve stocking efficiency and/or to enhance the aesthetics of the produce and the display and/or to increase accessibility of the back of the display to the consumer, in some embodiments of the invention. In some embodiments of the invention, the raised reservoir portion is used to supply fluids to produce displayed on the highest areas of the upper display portion. A contoured lip is provided to the raised reservoir portion for flow control of fluids from the raised reservoir portion to the remainder of the reservoir. Optionally, the fluid reservoir is provided with a drain hole to prevent over flowing.

There is thus provided in accordance with an exemplary embodiment of the invention, a produce display apparatus, comprising: a sloped upper display portion, with at least one slot and at least one aperture in the slot, for positioning produce with a root system therein; a fluid reservoir portion overlaid by the upper display portion, wherein at least a part of the root system of the produce positioned on the upper display portion is in fluid communication with fluid in the reservoir portion, wherein a non-root portion of the produce is substantially located above the upper surface of the upper display portion and the root system lies substantially below the upper display portion.

In an embodiment of the invention, the apparatus further comprises a raised reservoir portion located in the fluid reservoir portion and between the fluid reservoir portion and the upper display portion.

Optionally, a contoured lip is provided to the raised reservoir portion for flow control of fluids from the raised reservoir portion to the fluid reservoir portion.

In an embodiment of the invention, the apparatus further comprises a drain located in the fluid reservoir portion, wherein the top of the drain is located below the highest point of the fluid reservoir portion and wherein the drain is in fluid communication with an aperture in the bottom of the fluid reservoir portion.

In an embodiment of the invention, the apparatus further comprises a recirculating pump for returning fluid from the drain to the fluid reservoir portion.

In an embodiment of the invention, at least a portion of which is manufactured from a food-grade material. Optionally, the material is metal. Optionally, the material is plastic.

In an embodiment of the invention, the apparatus further comprises a grow light positioned above the upper display portion.

There is further provided in accordance with an exemplary embodiment of the invention, an array of for displaying produce, comprising: a plurality of produce display apparatuses, each produce apparatus comprising a sloped upper display portion, with at least one slot and at least one aperture in the slot, for positioning produce with a root system therein, a fluid reservoir portion overlaid by the upper display portion, wherein at least a part of the root system of the produce positioned on the upper display portion is in fluid communication with fluid in the reservoir portion, a drain located in the fluid reservoir portion, wherein the top of the drain is located below the highest point of the fluid reservoir portion and wherein the drain is in fluid communication with an aperture in the bottom of the fluid reservoir portion; and, tubing between the drain of a first apparatus in the array and at least one of the raised reservoir portion and the fluid reservoir portion of an apparatus downstream of the first apparatus.

In an embodiment of the invention, the array further comprises a recirculating pump for returning water from a drain of the farthest downstream apparatus in the array to at least one of the raised reservoir portion and the fluid reservoir portion of the first apparatus.

These and other features and their advantages will be readily apparent to those skilled in the art of produce display apparatuses from a careful reading of the Detailed Description of Exemplary Embodiments, accompanied by the following drawings.

### BRIEF DESCRIPTION OF THE DRAWINGS

Embodiments of the invention are herein described, by way of example only, with reference to the accompanying drawings. In this regard, the description taken along with the drawings makes apparent to those skilled in the art how embodiments of the invention may be practiced. It should also be understood that drawings may not be to scale. In the figures,

FIG. 1 is a perspective view of a produce display apparatus, in accordance with an exemplary embodiment of the invention;

FIG. 2 is an exploded view of a produce display apparatus, in accordance with an exemplary embodiment of the invention;

FIG. 3 is a perspective view of a fluid reservoir portion of the produce display apparatus, in accordance with an exemplary embodiment of the invention;

FIG. 4 is a front view of a fluid reservoir portion of the produce display apparatus, in accordance with an exemplary embodiment of the invention;

FIG. 5 is perspective view of a produce display apparatus with produce being displayed, in accordance with an exemplary embodiment of the invention; and,

FIG. 6 is a cross sectional view of a produce display apparatus with produce being displayed, in accordance with an exemplary embodiment of the invention.

### DETAILED DESCRIPTION OF EXEMPLARY EMBODIMENTS

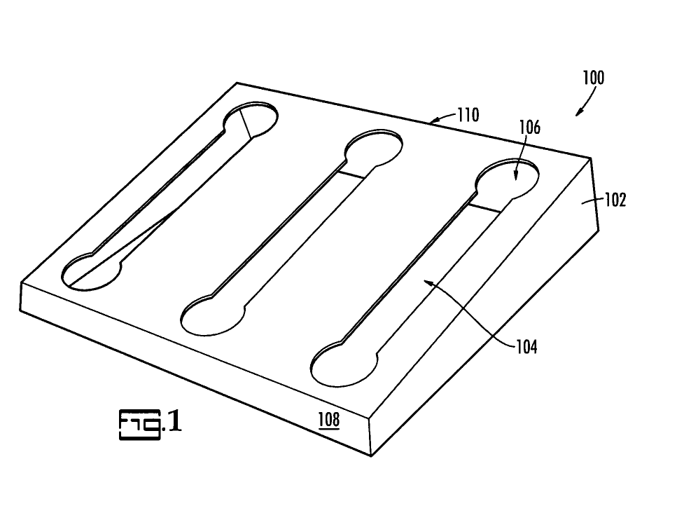

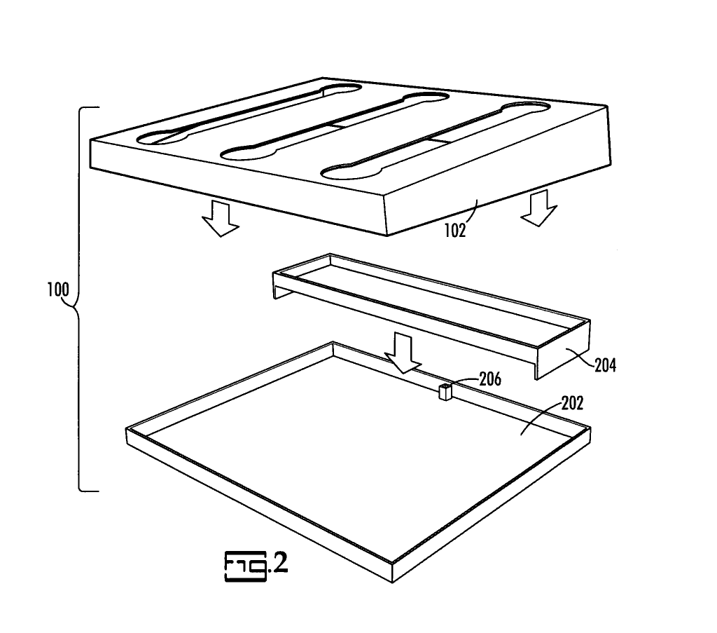

Referring to FIG. 1, a perspective view of a produce display apparatus 100 is shown, in accordance with an exemplary embodiment of the invention. Due to the configuration of apparatus 100, in an embodiment of the invention only the upper display portion 102 is visible in this view; other components of apparatus 100 are shown in more detail in FIGS. 2-4 and FIG. 6. In an embodiment of the invention, upper display portion 102 is sloped upwards going from front 108 to back 110. Upper display portion 102 is provided with at least one slot 104 for positioning produce therein, in accordance with an embodiment of the invention. In some embodiments of the invention, at least one enlarged aperture 106 is provided to the at least one slot 104. In some embodiments of the invention, the at least one aperture 106 is used to facilitate insertion and/or removal of the produce being displayed on the apparatus 100. For example, in an embodiment of the invention it is easier to insert the root system of the produce being displayed through enlarged aperture 106 than at least one slot 104, the corollary to that is that it is also easier to remove the produce from aperture 106 than slot 106. Additionally or alternatively, less damage will effectuated on the produce during apparatus 100 loading and consumer shopping if the aperture 106 is used for stocking and shopping instead of the slot 104. It should be understood that the shape and size of the at least one slot 104 and/or the at least one aperture 106 can be modified considering a number of factors, including the particular type of produce with which the apparatus 100 will be used. In addition, while apertures 106 are shown at the front 108 and back 110 of slot 104, at least one aperture 106 could be located at any point on the slot between the front 108 and back 110. At least one aperture 106 is sized so that produce being displayed on apparatus 100 is capable of being displayed (e.g. will not fall through the aperture) while resting in the aperture 106, in an exemplary embodiment of the invention. In some embodiments of the invention, apparatus 100 is provided with a plurality of different sized apertures 106. Apparatus 100 is adapted, in some embodiments, to store and/or display a plurality of different greens and herbs, including, bibb lettuce, oakleaf, spinach, kale, bok choi, chicory, and basil.

In some embodiments of the invention, produce is stocked using an aperture 106 at the back 110 of the apparatus 100 and due to the sloped nature of the face of the upper display portion 102 the produce slides down towards the front 108 of the apparatus 100, and optionally towards an aperture positioned at the front 108 of the apparatus, for retrieval by a consumer. In an embodiment of the invention, the slope is 5°. The slope of the upper display portion 102 is varied, in different embodiments of the invention, to alter performance characteristics, for example to increase or decrease the slidability of the produce on the upper display portion 102. Optionally, additionally and/or alternatively, the slope of the upper display portion 102 is used to enhance the aesthetics of the apparatus 100 and/or the produce, and/or accessibility of the produce displayed thereon to consumers. It should be understood that while apertures 106 are provided to facilitate stocking and shopping, both actions are optionally, additionally and/or alternatively performed via at least one slot 104.

In some embodiments of the invention, apparatus 100 is adapted to be used with conventional grocery store produce retail shelves. For example, apparatus is optionally 24 to 36 inches wide and 14 to 24 inches front 108 to back 110. In an embodiment of the invention, the apparatus 100 is approximately 20 inches from front 108 to back 110 and 24 inches wide. In some embodiments, the apparatus is approximately 1¾ inches tall at the front 108 and 3½ inches tall in the back 110. In some embodiments of the invention, the apparatus 100 is adapted to be used at a consumer's home, for example on a counter top or table top. In a home embodiment of the invention, the apparatus 100 is approximately 14 inches from front 108 to back 110 and 24 inches wide. In some embodiments, the apparatus is approximately 1¾ inches tall at the front 108 and 3 inches tall in the back 110. It should be understood that these are exemplary sizes only, and that apparatus 100 could exhibit a plurality of dimension combinations depending on the intended use (e.g. location of display, produce being displayed, and/or aesthetic considerations).

In an embodiment of the invention, at least a portion of the apparatus 100, for example upper display portion 102, is constructed from a food grade material. Optionally, the food grade material is metal, such as stainless steel. Optionally, the food grade material is a plastic, such as polylactide (PLA). Apparatus 100 is manufactured in consideration of the materials chosen for manufacturing and using methodologies known to those skilled in the art, for example stamping, thermoforming and/or injection molding.

FIG. 2 is an exploded view of a produce display apparatus 100 showing upper display portion 102, a fluid reservoir portion 202 and an optional raised reservoir portion 204, in accordance with an exemplary embodiment of the invention. In some embodiments of the invention, produce positioned on the upper display portion 102 is placed so that at least a part of the produce (e.g. the roots) touches the fluid in the fluid reservoir 202, shown and described in more detail with respect to FIG. 6. Optionally, raised reservoir portion 204 is provided so that produce being displayed towards the back 110 of the apparatus 100, being higher than the produce towards the front 108 of the apparatus 100 as a result of the slope, has approximately the same distance from the upper display portion 204 to the fluid as the produce towards the front 108 of the display tray 102. Produce positioning on the apparatus 100 is shown in more detail with respect to FIG. 6.

In some embodiments of the invention, a drain 206 is provided to apparatus 100 to prevent an overflow of the fluid reservoir portion 202. Drain 206 is located in the fluid reservoir portion 202 and/or comprises a vertical hollow tube through which fluids can pass, in some embodiments of the invention. Drain 206 is placed vertically in fluid reservoir portion 202 above an aperture in the base of the fluid reservoir 202 such that when fluid enters the highest point of drain 206, the fluid flows through drain 206 and out of reservoir portion 202 through the aperture in the base. In an embodiment of the invention, drain 206 is utilized when the fluid level in the fluid reservoir portion 202 gets to an undesirable high level. The top of the drain 206 is placed at least slightly below the highest level of the fluid reservoir portion 202 wall such that water would flow into the drain before flowing over the wall of the reservoir portion 202, in an embodiment of the invention.

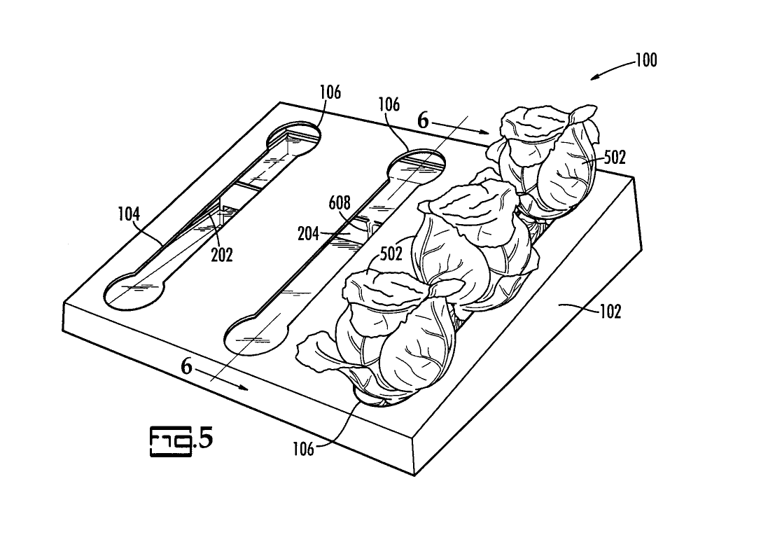

In some embodiments of the invention, apparatus 100 is filled with fluid by filling the raised reservoir portion 204, if present, and subsequently as it overflows, optionally via a contoured lip 402 described and shown in more detail with respect to FIG. 4, the fluid reservoir portion 202. In embodiments without raised reservoir portion 204, the fluid reservoir portion 202 is filled directly. In some embodiments of the invention, because the apparatus 100 is adapted to be displayed on commercial grocery store produce shelves, which often include a means for hydrating the produce being displayed thereon (i.e. “wet racks”), the apparatus 100 is optionally filled by attaching the apparatus 100 to the hydration system of the shelving. For example, a pipe or tubing is used to establish fluid communication between the hydration system of the shelving and the raised reservoir portion 204. In some embodiments of the invention, a recirculating pump is used to return fluid from drain 206 to raised reservoir portion 204.

In an embodiment of the invention, an array of interconnected apparatuses 100 is used to display produce. In some embodiments of the invention, as fluid eventually overflows the fluid reservoir portion 202 and flows through the drain 206, the draining fluid is used to fill a second produce display apparatus positioned downstream of the first apparatus 100 and placed in fluid communication with the first apparatus by attaching tubing to drain 206 and running the tubing into the raised reservoir portion of the second apparatus. In some embodiments of the invention, a recirculating pump is used at the final drain outlet (the drain of the last apparatus in the array) to return fluid to the hydrating system and/or first apparatus 100.

In some embodiments of the invention, beneficial lighting, for example a grow light, is positioned above apparatus 100 to assist in sustaining and/or improving the freshness and/or shelf life of the produce 502 being displayed.

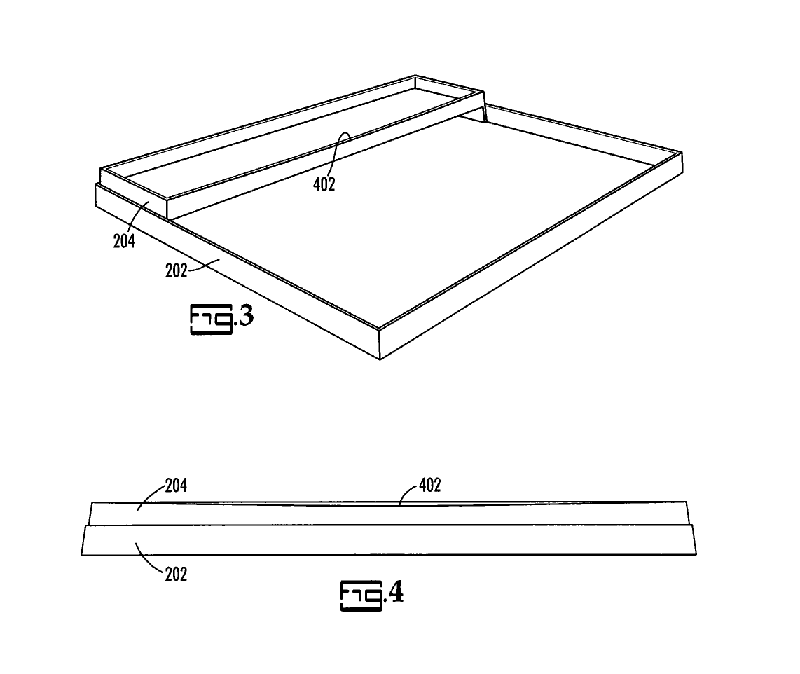

FIG. 3 is a perspective view of fluid reservoir portion 202 and the raised reservoir portion 204 of the produce display apparatus 100 combined, in accordance with an exemplary embodiment of the invention. FIG. 4 is a front view of fluid reservoir portion 202 and the raised reservoir portion 204 showing the contoured lip 402 provided to the raised reservoir portion 204 for flow control of fluids from the raised portion 204 to the fluid reservoir portion 202 and/or for overflow control for the raised portion 204.

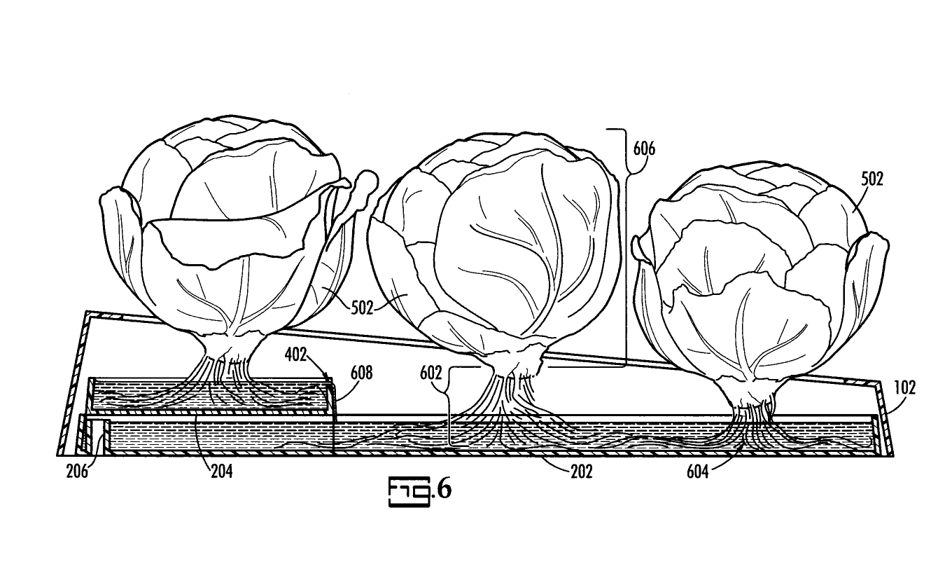

FIG. 5 is perspective view of a produce display apparatus 100 with produce 502 being displayed on upper display portion 102, in accordance with an exemplary embodiment of the invention. FIG. 6 is a cross sectional view taken from FIG. 5, of produce display apparatus 100 with produce 502 being displayed, in accordance with an exemplary embodiment of the invention. In an embodiment of the invention, produce 502 is placed in the upper display tray 102 such that at least a portion of the root 602 of the produce 502 touches the fluid 604 in the fluid reservoir 202. The leafy portion 606, or non-root portion, of the produce 502 is positioned above the surface of the upper display portion 102, in some embodiments of the invention. Also shown in FIG. 6 is fluid 608 from the raised reservoir portion 204 flowing via contoured lip 402 into fluid reservoir portion 202 as a result of the fluid level in the raised reservoir portion 204 exceeding the height of the contoured lip 402. Fluid 604, 608 is optionally nutritionally enriched as is customary in the hydroponic art.

Unless otherwise defined, all technical and/or scientific terms used herein have the same meaning as commonly understood by one of ordinary skill in the art to which the invention pertains. In case of conflict, the patent specification, including definitions, will control. In addition, the materials, methods, and examples are illustrative only and are not intended to be necessarily limiting.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting

Those familiar with produce display apparatuses will appreciate that many modifications and substitutions can be made to the foregoing preferred embodiments of the present invention without departing from the spirit and scope of the present invention, defined by the appended claims.

What is claimed is:

1. A produce display apparatus, comprising:
a sloped upper display portion, with at least one slot and at least one aperture in the slot, for positioning produce with a root system therein;
a fluid reservoir portion overlaid by the upper display portion, wherein at least a part of the root system of the produce positioned on the upper display portion is in fluid communication with fluid in the reservoir portion,
wherein a non-root portion of the produce is substantially located above the upper surface of the upper display portion and the root system lies substantially below the upper display portion.

2. An apparatus according to claim 1, further comprising a raised reservoir portion located in the fluid reservoir portion and between the fluid reservoir portion and the upper display portion.

3. An apparatus according to claim 2, wherein a contoured lip is provided to the raised reservoir portion for flow control of fluids from the raised reservoir portion to the fluid reservoir portion.

4. An apparatus according to claim 1, further comprising a drain located in the fluid reservoir portion, wherein the top of the drain is located below the highest point of the fluid reservoir portion and wherein the drain is in fluid communication with an aperture in the bottom of the fluid reservoir portion.

5. An apparatus according to claim 4, further comprising a recirculating pump for returning fluid from the drain to the fluid reservoir portion.

6. An apparatus according to claim 1, at least a portion of which is manufactured from a food-grade material.

7. An apparatus according to claim 6, wherein the material is metal.

8. An apparatus according to claim 6, wherein the material is plastic.

9. An apparatus according to claim 1, further comprising a grow light positioned above the upper display portion.

10. An array of for displaying produce, comprising:
a plurality of produce display apparatuses, each produce apparatus comprising
a sloped upper display portion, with at least one slot and at least one aperture in the slot, for positioning produce with a root system therein,
a fluid reservoir portion overlaid by the upper display portion, wherein at least a part of the root system of the produce positioned on the upper display portion is in fluid communication with fluid in the reservoir portion,
a drain located in the fluid reservoir portion, wherein the top of the drain is located below the highest point of the fluid reservoir portion and wherein the drain is in fluid communication with an aperture in the bottom of the fluid reservoir portion; and,
tubing between the drain of a first apparatus in the array and at least one of the raised reservoir portion and the fluid reservoir portion of an apparatus downstream of the first apparatus.

11. An array according to claim 10, further comprising a recirculating pump for returning water from a drain of the farthest downstream apparatus in the array to at least one of the raised reservoir portion and the fluid reservoir portion of the first apparatus.
